(19) United States
(12) Patent Application Publication
(10) Pub. No.: US 2017/0188730 A1
(43) Pub. Date: Jul. 6, 2017

(54) DRINKING CONTAINER WITH SMART COMPONENTS FOR MEASURING VOLUMES OF LIQUIDS VIA FLUIDIC OSCILLATION

(71) Applicant: IGNITE USA, LLC, Chicago, IL (US)

(72) Inventors: Tim Schuller, Cambridge (GB); Martyn Mitchell, Hertfordshire (GB); Thomas Barlow, Cambridge (GB)

(73) Assignee: IGNITE USA, LLC, Chicago, IL (US)

(21) Appl. No.: 15/391,158

(22) Filed: Dec. 27, 2016

Related U.S. Application Data
(60) Provisional application No. 62/275,696, filed on Jan. 6, 2016.

(51) Int. Cl. A47G 23/16; B65D 47/06; H04Q 9/00; A47G 19/22; B65D 51/24; B65D 43/02; A47G 21/18

(52) U.S. Cl. CPC A47G 23/16; B65D 43/0225; B65D 47/06; A47G 21/18; A47G 19/2272; B65D 51/245; H04Q 9/00

(57) ABSTRACT

A smart bottle comprising a lid and container body includes a fluidic oscillator, an actuator, a drinking interface, a sensor comprising a microphone, a processor, an antenna and a battery disposed in the smart bottle. The smart bottle utilizes the various components to measure liquid consumption of a user in one or more drink events.

### CROSS-REFERENCE TO RELATED APPLICATIONS

This claims the benefit of U.S. Provisional Application No. 62/275,696 (filed Jan. 6, 2016), the entirety of which is incorporated by reference herein.

### TECHNICAL FIELD

The present invention relates generally to drinking containers, and more particularly to a smart drinking container and a smart lid configured to measure the volume of liquid consumed by a user via fluidic oscillation techniques.

### BACKGROUND OF THE INVENTION

Drinking containers, including travel mugs, water bottles, and tumblers, are well known in the art. While such drinking containers according to the prior art provide a number of advantageous features, they do not reliably measure the amount of liquid consumed by a user. A full discussion of the features and advantages of the present invention is deferred to the following detailed description, which proceeds with reference to the accompanying drawings.

### BRIEF DESCRIPTION OF THE DRAWINGS

To understand the present invention, it will now be described by way of example, with reference to the accompanying drawings in which:

FIG. 1 is a front perspective view of one embodiment of a smart drinking container according to the present invention which is configured to measure the volume of liquid consumed by a user via fluidic oscillation;

FIG. 2 is an illustration of a diagram of the fluidic oscillator disposed in a fluid pathway;

FIG. 3 is a cross section view of one embodiment of a smart lid according to the present invention which is configured to measure the volume of liquid consumed by a user via fluidic oscillation;

FIG. 4 is a flow diagram illustrating one embodiment of a method for measuring the volume of liquid withdrawn from a container body using a smart drinking container implementing an exemplary fluidic oscillation technique according to the present invention.

### DETAILED DESCRIPTION

While the invention described herein is susceptible of embodiments in many different forms, there is shown in the drawings and will herein be described in detail preferred embodiments of the invention with the understanding that the present disclosure is to be considered as an exemplification of the principles of the invention and is not intended to limit the broad aspects of the invention to the embodiments illustrated.

The present application provides a smart drinking container that can reliably measure the liquid consumption of a user. According to the present invention, a fluidic oscillation technique is used to measure the volume of liquid withdrawn from the smart drinking container during one or more drink events. For example, a fluid pathway structure disposed in a container body and/or a lid of the smart drinking container is fluidly coupled to a drinking interface of the lid. The fluid pathway defines a flow path which all liquid exiting the container (and consumed by a user) must pass through, which enables accurate measurement of the amount of liquid consumed by a user. Further, the fluid pathway includes a “fluidic oscillator,” which is a structure comprising one or more flow diverters influencing oscillations of the fluid flowing through the fluid pathway.

Fluid flowing through the fluidic oscillator has an oscillation frequency proportional to the fluid flow rate. Measurement of this oscillation rate can then be used to calculate the volume of fluid passing through the fluidic oscillator. Frequency of oscillation is dependent upon the size of the device, but for suitably small fluidic oscillators across the anticipated range of flow rates, the frequencies are generally predicted to be in the range of 0-50 Hz.

The volume of liquid flowing through the fluidic oscillator, Q, can be determined using the following relationship:

Q=fdA/St where, f is the oscillation frequency, d is the characteristic dimension of the oscillator (e.g., the oscillator having a fluid pathway therethrough, the fluid pathway having a diameter d), A is the outlet cross-sectional area and St is the Strouhal number (a dimensionless number which is determined by the design of the fluidic oscillator and provides a measurement of oscillation linearity with flow rate).

The oscillations can be detected acoustically by using a microphone outside of the fluid pathway, but adjacent to the position of the fluidic oscillator, if the wall of the fluid pathway is sufficiently thin to transmit the acoustic signature.

The smart drinking container can begin to measure the liquid withdrawn through a drinking interface (and subsequently through the fluidic oscillator of the fluid pathway) from a defined starting point. The starting point can occur at regular intervals (hour, day, etc.) or at a point selected by a user. The smart drinking container may then measure liquid withdrawn from the container during “drink events”, i.e., throughout the duration in which a user consumes, sips, and/or drinks liquid from the container.

To perform the necessary measurements and calculations, the smart drinking container typically includes various components, which are communicatively coupled to one another and powered by a battery or other power source. For example, such components, generally referred to herein as “smart components,” include a processor, an actuator, a sensor such as, for example, a microphone, and optionally an antenna.

In an embodiment of the present invention, the smart drinking container may measure the volume of liquid withdrawn through a drinking interface by recording and analyzing the acoustic signature of the liquid as it flows out of the container. In one aspect, the volume of liquid flowing out of the drinking container is recorded during a drink event (e.g., while a user sips from a tumbler using a straw in fluid communication with the liquid contents of the tumbler, or while a user sips from a drinking aperture provided in a lid of a travel beverage container, or while a user sips from a spout of a water bottle), whereby the recording is initiated through activation of an actuator at the beginning of a drink event.

In another embodiment, the smart drinking container may record and analyze the acoustic signature of the air that flows into the container during a drink event to determine the amount of liquid that is withdrawn through a drinking interface during one or more drink events. For example, the fluidic oscillator may be displaced in a fluid pathway fluidly coupled to a vent aperture (not shown) of the drinking container.

The smart components of the drinking container according to the invention can be installed on or within a container body, on or within a lid for use in combination with a container body, and/or on or within any suitable combination of the container body and the lid. In an exemplary embodiment, each of the smart components may be installed within the lid. In such an embodiment, the lid, referred to herein as a “smart lid”, provides several advantages. For example, the smart lid according to the invention may be compatible with various container bodies (of different size and/or shape), thus allowing a user to couple the smart lid to any suitable liquid container.

In another exemplary embodiment, the smart components may be installed within the container body. Such an embodiment may be easier to manufacture due to the increased room for positioning the smart components compared to the smart lid. In other embodiments, the smart components can be distributed on or within both the lid and the container body.

Numerous drinking containers including but not limited to travel mugs (for example, as disclosed in U.S. Pat. No. 7,546,933, which is hereby incorporated by reference herein), water bottles (for example, as disclosed in U.S. Pat. No. 8,602,238, which is hereby incorporated by reference herein), and tumblers, can be configured to be smart drinking containers according to the invention. In addition, drinking containers typically used for “serving” such as pitchers and thermoses can also be configured to be smart drinking containers according to the invention.

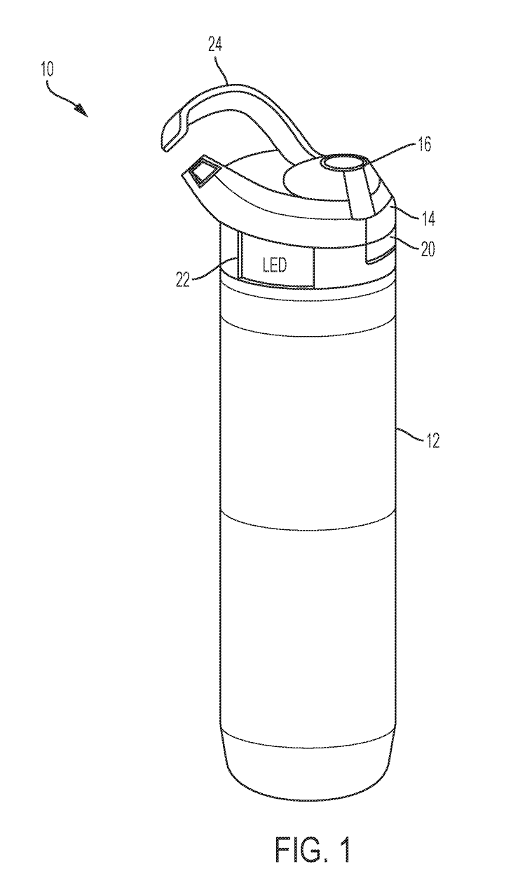

Referring now to the Figures, FIG. 1 shows an embodiment of a smart drinking container according to the present invention, specifically, a smart water bottle 10. The smart water bottle 10 is generally comprised of a container body 12 for holding liquid, which optionally may have a dual-walled construction, and a lid assembly 14 that may be sealably fastened and releasably coupled to the container body 12. If the container body has a dual-walled construction, such a dual-walled construction can be insulated with an insulating foam provided in a cavity between the walls or with a vacuum sealed construction to increase the thermal efficiency of the smart water bottle 10. The container body 12 may store a variety of liquids, both hot and cold, and thus the term “water bottle” as used herein is not limited to storing water. It will be recognized by those of ordinary skill in the art that each such component may be formed by single or multiple elements, separately or integrally formed. For example, the container body 12 may further include an overmold sleeve (not shown) to improve the user's ability to grip the container body and/or the aesthetic appearance thereof. As another example, the lid assembly 14 may include a handle element 24 and the handle 24 may include a carabiner-type element (not shown) that may allow the handle to be releasably coupled to another object such as a backpack strap or allow another object such as a key ring to be releasably coupled to the handle 24.

As explained in detail herein, the lid assembly 14 generally contains a drinking interface 16, disposed on or in a top surface of the lid 14, which allows a user to consume liquid contained within the container body 12. Exemplary drinking interfaces 16 include a spout extending from a top surface of the lid assembly 14, a drink aperture extending through a top surface of the lid assembly 14, or a straw, with each being in fluid communication with an interior of and any fluid contents contained within the container body 12. In the illustrated embodiment, the drinking interface 16 is a spout. The illustration of FIG. 1 is not intended to be limiting; indeed the structures of numerous liquid containers that may be further adapted to provide smart drinking containers according to the invention are well known in the art. In general, the drinking interface 16 can be of any suitable form provided that the drinking interface 16 may be used by a user to consume liquid from the drinking container 10. For example, the drinking interface 16 may comprise a straw, a spout, a nozzle, a drinking aperture, etc.

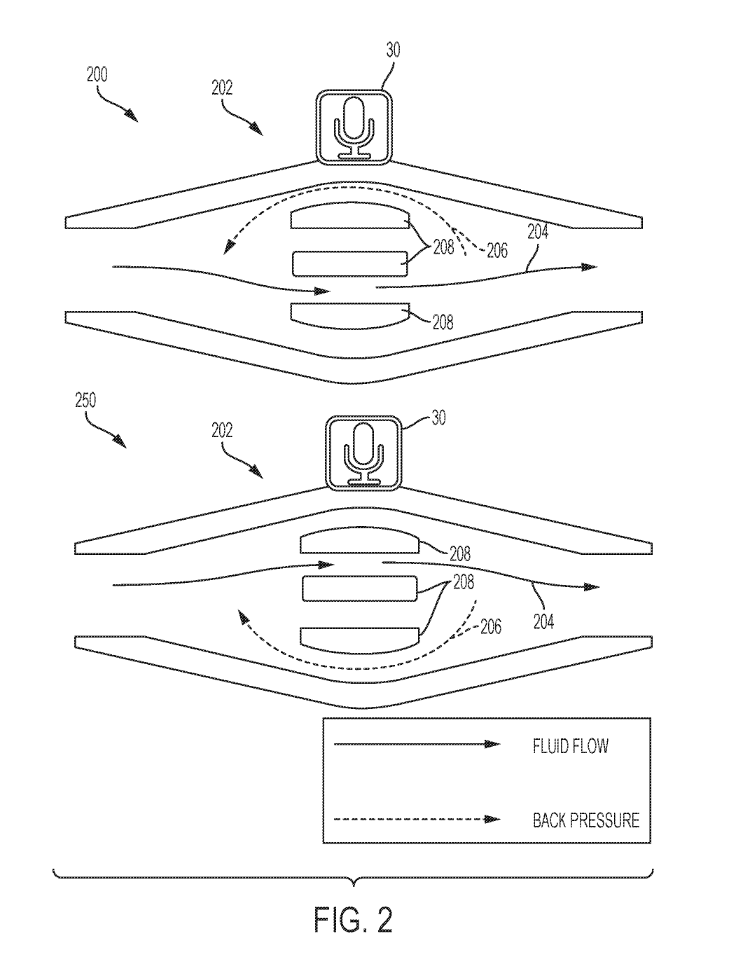

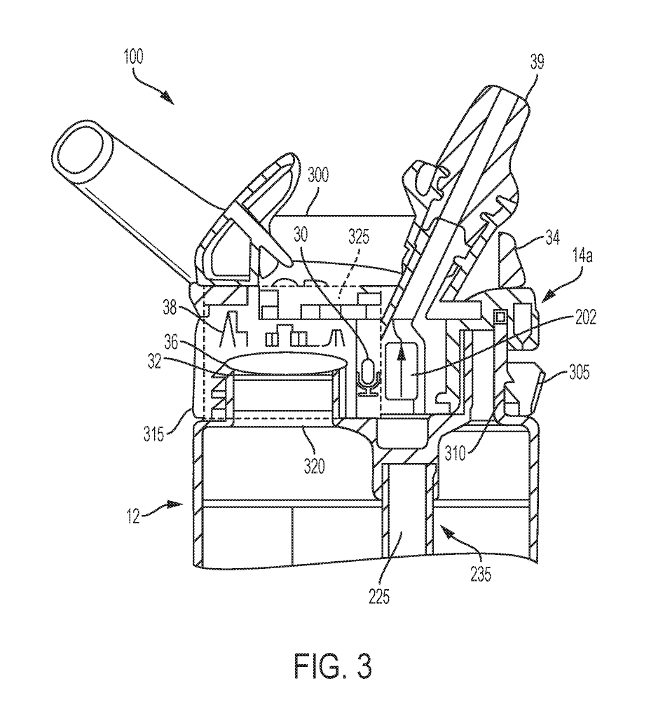

As mentioned above, the drinking interface 16 is fluidly coupled to a fluid pathway 225 that extends into the container body 12. In the embodiment illustrated in FIG. 3, the fluid pathway 225 is an internal dipstick 235 which is a relatively narrow tube that extends into the container body 12. The internal dipstick 235 includes a fluidic oscillator 202 comprising bluff bodies (corresponding to the flow diverters described above) which can produce a flow of liquid which oscillates between paths created by the bluffs. FIG. 2 is an illustration of a diagram of the fluidic oscillator disposed in a fluid pathway of a representative drinking interface.

FIG. 2 illustrates two examples, 200 and 250, of fluid flowing through the fluidic oscillator 202 displaced in a fluid pathway 225 such as an internal dipstick 235 of the smart water bottle 10. The fluidic oscillator 202 comprises bluff bodies 208 which provide sub-fluid pathways within the fluid pathway 225 for fluid to flow through. Although the fluidic oscillator 202 illustrated in FIG. 2 comprises three bluff bodies 208, this is not intended as a limiting feature, and the fluidic oscillator 202 may contain one or more bluff bodies 208 forming sub-fluid pathways of any suitable size and shape within the fluid pathway 225. In the example 200, the fluid flow 204 runs through the third sub-fluid pathway (from the top) and creates a back pressure 206 which flows through the first sub-fluid pathway. In the example 250, the fluid flow 204 runs through the second sub-fluid pathway while the back pressure 206 flows through the fourth sub-fluid pathway. The illustrations 200 and 250 are intended to be examples of fluid flow through a fluidic oscillator and are not intended to be limiting. Any combination of fluid flow and back pressure may pass through the fluidic oscillator. The microphone 30 records the acoustic signature created by the fluid flow 204 and back pressure 206 as fluid moves through the fluidic oscillator. During a single drink event, the fluid flow 204 can alternate through the different sub-fluid pathways within the fluid pathway 225. The microphone 30 can record the changes in the acoustic signature caused by the fluid flow 204, which in turn can be analyzed, for example, by a processor, to calculate the amount of fluid withdrawn from the container throughout the drink event.

Referring back to FIG. 1, the smart water bottle 10 includes one or more actuators that, when activated, initiates the microphone to record the acoustic signature of the liquid flowing through the fluidic oscillator throughout the drink event. In one embodiment, the actuator can take the form of an external button 20 accessible from the exterior of the smart drinking container 10 (e.g., on an exterior surface of the lid assembly 14), that when depressed, operates to pivot a shutter (not shown) and thereby open and close a seal (not shown) on the shutter for sealing the drinking interface 16. Thus, when the button 20 is depressed, liquid can be dispensed from the drinking interface 16 of the smart bottle 10 such that a user can consume liquid directly therefrom, i.e., a drink event has commenced. Once a drink event has commenced, the smart water bottle 10 may begin to record the acoustic signature of the liquid being withdrawn during the drink event. According to this embodiment, release of the button 20 indicates to the processor (not shown in FIG. 1) that a drink event has ended, and thus release of the button 20 causes the drink event, and consequently the recording, to end. In another embodiment, the actuator 20 takes the form of a button accessible from the exterior of the smart drinking container 10 (e.g., on an exterior surface of the lid assembly 14), that either when depressed or when released, indicates to the processor (not shown) that a drink event is ongoing, and thus depression or release of the button 20 causes the acoustic signature of liquid being withdrawn from the container body 12 to be automatically recorded.

In other embodiments, as best illustrated in FIG. 3, the actuator is located in an interior enclosed compartment 325 of the lid assembly 14 and/or container body 12. For example, the actuator may be a tilt switch disposed in the interior compartment, which is activated when the lid assembly 14 is turned a number of degrees from vertical. As an example, the tilt switch can be configured to detect when the lid assembly 14a is tilted more than 15 degrees from vertical, more than 20 degrees from vertical, more than 25 degrees from vertical, more than 30 degrees from vertical, more than 35 degrees from vertical, more than 40 degrees from vertical, more than 45 degrees from vertical, and/or more than 50 degrees from vertical.

In another embodiment, the actuator may be cx disposed within the fluid path. For example, the actuator may comprise conductive pins within the fluid path. The conductive pins may act as an electronic sensor that is activated when at least two pins are in contact with liquid. In this embodiment, the conductive pins may detect when liquid is moving through the fluid path, which would indicate a drink event. In an exemplary embodiment, the conductive pins may be located in the fluid pathway adjacent to the fluidic oscillator. In other embodiments, the conductive pins may be located in any suitable location along the fluid pathway.

In other embodiments, the actuator may be a micro switch, a vibration switch, a touch sensor, for example, a conductivity-based touch sensor, or any other suitable sensor configured to detect a drink event. In further embodiments, there may be one or more actuators, communicatively coupled to each other and the other smart components, which can each include different functionality for receiving an indication of a drink event. For example, the actuator of the smart bottle 10 may include one or more of a button 20 as described above and a tilt switch.

Typically, the type of actuator employed in a smart drinking container according to the invention depends on the specific form of the smart drinking container 10. For example, a smart drinking container 10 that takes the form of a tumbler including a straw may not be compatible with a tilt switch, because a user will typically hold the smart tumbler 10 in a vertical position while drinking from the straw.

Further, the actuator may be implemented as any combination of mechanical, electronic and/or chemical components. For example, the actuator may initiate recordation of a drink event by employing any combination of sensors and button mechanisms working in unison to determine when a drink event occurs. For example, the actuator may include a button and a tilt sensor. In this example, the drink event may not commence until the both the button is depressed and the bottle is tilted a number of degrees from vertical. The drink event may then end once either the button is released and/or the bottle is returned to a sufficiently vertical position.

Still further, the smart water bottle 10 may include an LED display 22. The LED display may be provided on an exterior surface of the smart bottle 10. In preferred embodiments, the LED display may be disposed on an external sidewall of either the container body 12 or the lid assembly 14. The LED display 22 may be communicatively coupled to the smart components of the smart drinking container 10, as discussed in greater detail below. The LED display may display the amount of liquid consumed by a user on one or more regularly occurring bases, for example, the LED display may display the amount of liquid consumed by the user on a daily basis, a weekly basis, and/or a monthly basis. Further, the LED display may be selectively reset by the user to start measuring the amount of liquid consumed at any time, i.e., the LED display may selectively display the amount of liquid consumed by the user over any selected time period. Thus, in various embodiments, the LED display 22 may illustrate data related to the smart drinking container 10 and more particularly to liquid consumption by the user over one or more pre-defined and/or selected periods of time. Further, the LED display 22 may also include digital representations illustrating the current time, the current temperature, the current barometric pressure, the current battery life, and/or a digital map. For example, in one exemplary embodiment, the LED display 22 may indicate a remaining battery power of a battery of the smart drinking container 10, a total volume of liquid displaced/consumed over one or more drink events and other information related to the smart water bottle 10. In some embodiments, the LED display 22 may be a display of a corresponding device (i.e. a smart phone, a tablet, a smart watch, or a PC) communicatively coupled to the smart bottle 10 via Bluetooth, fire wire, Wi-Fi, USB, etc., as discussed in greater detail below with respect to the antenna.

As explained above, the smart drinking container 10 may be a bottle including various smart components for measuring the volume of a liquid withdrawn from the drink bottle 10 during one or more drinking events. The smart drinking container 10 may comprise a smart lid, i.e., a lid assembly 14 that contains all of the smart components. In another embodiment, the smart drinking container 10 may have all the smart components disposed on or within the container body 12. In still another embodiment, the smart components are disposed on or within both the lid 14 and the container body 12 of the smart drinking container 10.

Referring again to FIG. 3, a cross-sectional view showing internal features of a smart lid 14a is illustrated. In the embodiment illustrated in FIG. 3, the lid assembly is a smart lid 14a that contains all of the smart components of a smart drinking container 10. Generally, the smart lid 14a comprises a top lid surface 300, a sidewall 305 extending down annularly from the top lid surface 300 and terminating at a bottom edge 320, the annular sidewall 305 having an internal portion 310 and an external portion 315, where a section of the internal portion 310 may include threading for sealably fastening and releasably coupling the smart lid 14a to a container body 12. An interior, enclosed compartment 325 can be provided on an interior surface of the smart lid 14a. Such a compartment 325 can be referred to as an “in-lid” compartment because it is wholly contained between the top lid surface 300 and the bottom edge 320 of the smart lid 14a. Of course, a compartment external to the lid can also be used to contain the smart components of the smart drinking container 10, but an in-lid compartment is generally found to be more aesthetically pleasing and uses available space more efficiently.

The illustration of the smart lid 14a includes a drinking interface 39 which differs from the drinking interface 16 of FIG. 1 and is intended to illustrate a different embodiment of a drinking interface that can be utilized in a smart drinking container 10 according to the invention. The drinking interface 39 is fluidly coupled to fluid pathway provided by a straw-like structural element, referred to herein as an “internal dipstick,” 235 that extends beyond the bottom edge 320 of the annular sidewall 305 and is in fluid communication with the fluid contents contained within the interior of the container body 12. In an embodiment of the current invention, the internal dipstick 235 includes a fluidic oscillator 202, as discussed above.

As mentioned above, the smart lid 14a includes all of the “smart components” according to the invention, and these components are communicatively coupled to one another and powered by a battery 32 or other power source such as a solar cell. The smart components work together to determine that a drink event has commenced and, thus, that the volume of liquid being withdrawn from the container should be recorded throughout the drink event. The smart components include a sensor comprising a microphone 30, an actuator 34, a processor 36, and may further include an antenna 38. The processor 36 may include a memory to store a total volume of fluid withdrawn (i.e., consumed), and/or any other information related to the smart drinking container 100. Although the actuator 34 of FIG. 3 is a push button actuator disposed on the external portion 315 of the sidewall 305, other actuators can be used in lieu of or in combination with actuator 34 as described above.

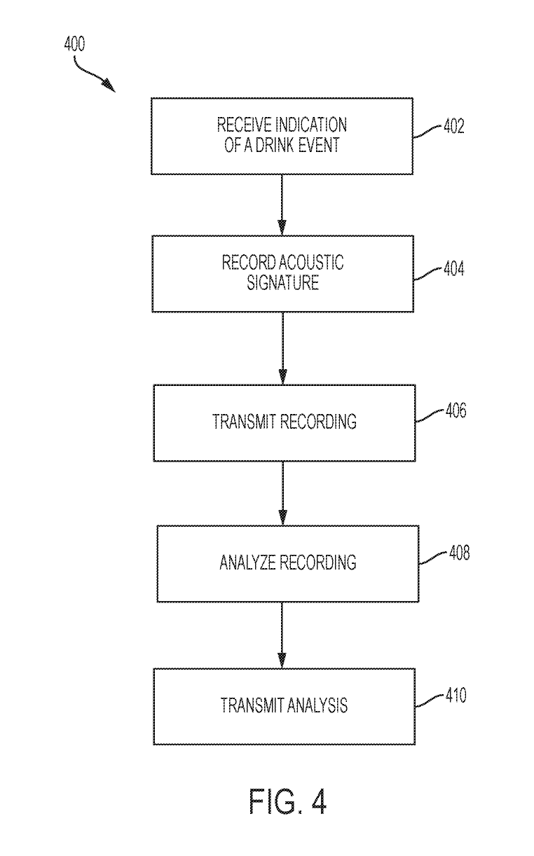

FIG. 4 illustrates a flow diagram of an example method 400 for measuring the volume of liquid withdrawn from a smart drinking container incorporating the representative smart components illustrated in FIG. 3, i.e., microphone 30, actuator 34, processor 36, and optionally antenna 38. Upon receiving an indication that a drink event has commenced (Block 402) via activation of the actuator, the smart components act in concert to measure the volume of liquid being withdrawn from container body 12 throughout the drink event. Once the actuator is activated, and thus, the drink event has commenced, the microphone 30 is implemented to record an acoustic signature of the liquid flow (and/or air flow) throughout the drink event (Block 404). In some embodiments, the sensor 30 comprises a piezoelectric disc microphone, also known as a piezo or contact microphone. In other embodiments, the sensor 30 comprises a condenser electret microphone. Further, any suitable sensor comprising a microphone 30 may be utilized by the smart bottle 10.

Upon completion of the drink event, the recorded acoustic signature is then transmitted via wired connections to the processor 36 (Block 406). The processor 36 may then analyze the recorded acoustic signature to determine the volume of liquid withdrawn during the drink event (Block 408). In one embodiment, the processor 36 may analyze the frequency of the recorded acoustic signature by implementing a frequency counter. However, other known suitable techniques can be used to analyze the recorded acoustic signature of the liquid flowing through the fluidic oscillator 202.

In another embodiment, the recorded acoustic signature may be transmitted to a server for analysis. The server may perform any of the calculations described with regard to the processor 36 above. In still other embodiments, a combination of a server and processor 36 may be enabled to calculate and store measurements of displaced liquid per drink event and/or a total volume of liquid displaced during multiple drink events.

Once the processor 36 analyzes the recorded acoustic signature, the analysis may be transmitted through wired connections to an LED display (such as the LED display 22 of FIG. 1) and/or through the antenna 38 to corresponding smart devices (Block 410). For example, the antenna 38 may be allow the smart bottle to communicate with a smart phone, a tablet, a smart watch a personal computer or any other suitable computing device. The antenna may implement known wireless communication methods such as Bluetooth, Wi-Fi, radio waves, etc. Further, the antenna 38 may be configured to transmit signals to a server of a web application. The web application may be accessed by a user to view various data related to liquid consumption from the smart bottle.

Several alternative embodiments and examples have been described and illustrated herein. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. Additionally, the terms “first,” “second,” “third,” and “fourth” as used herein are intended for illustrative purposes only and do not limit the embodiments in any way. Further, the term “plurality” as used herein indicates any number greater than one, either disjunctively or conjunctively, as necessary, up to an infinite number. Additionally, the term “having” as used herein in both the disclosure and claims, is utilized in an open-ended manner.

It will be understood that the invention may be embodied in other specific forms without departing from the spirit or central characteristics thereof. The present disclosure and the illustrated embodiments, therefore, are to be considered in all respects as illustrative and not restrictive, and the invention is not to be limited to the details given herein. Accordingly, while specific embodiments have been illustrated and described, numerous modifications are readily apparent to one having ordinary skill in the art and the scope of protection should only be limited by the scope of the accompanying claims.

What is claimed:

1. A smart lid for a drinking container comprising:
a drinking interface, on or in a top surface of the smart lid, for drinking:
a fluid pathway fluidly coupled to the drinking interface and extending from the smart lid, the fluid pathway being disposed opposite the drinking interface;
a fluidic oscillator disposed within the fluid pathway;
a group of communicatively coupled smart components disposed on or within the smart lid, the smart components comprising:
an actuator which, when activated, indicates a drink event,
a sensor comprising a microphone, located adjacent to the fluidic oscillator of the drinking interface, for recording an acoustic signature of fluid flowing through the fluidic oscillator throughout the duration of the drink event,
a processor, for analyzing the recorded acoustic signature, and
optionally, an antenna, for transmitting the analysis of the processor; and
a power source, for supplying power to the smart components;
wherein the smart lid, when coupled to a container body, is configured to measure a volume of liquid withdrawn from the container body during the drink event based on the analysis of the processor.

2. The smart lid of claim 1, wherein the actuator is located on an external sidewall of the smart lid and wherein the actuator is activated by a physical stimulus.

3. The smart lid of claim 1, further comprising an LED display, located on an external sidewall or the top surface of the smart lid.

4. The smart lid of claim 1, wherein the antenna is configured to transmit the analysis to a corresponding device, wherein the corresponding device can be a smart phone, a tablet, a personal computer or a smart watch.

5. The smart lid of claim 1, wherein the antenna is configured to transmit the analysis to a server of a web application.

6. The smart lid of claim 1, wherein the drinking interface comprises one or more of a spout extending from the top surface, a drink aperture extending through the top surface, or a straw in fluid communication with an interior of the container body.

7. The smart lid of claim 1, wherein the actuator comprises a mechanical component, an electronic component, a chemical component, or a combination thereof.

8. The smart lid of claim 1, wherein the smart lid is configured to determine a total volume of liquid displaced during one or more drink events.

9. A smart drinking container comprising:
a lid including a drinking interface, on or in a top surface of the lid, for drinking from the smart drinking container;
a container body;
a fluid pathway fluidly coupled to the drinking interface and extending into the container body;
a fluidic oscillator disposed within the fluid pathway;
a container body coupled to the lid;
a group of communicatively coupled smart components disposed on or within one or both of the container body and the lid, the smart components including:
an actuator which, when activated, indicates a drink event,
a sensor comprising a microphone, located adjacent to the fluidic oscillator of the drinking interface, for recording an acoustic signature of fluid flowing through the fluidic oscillator throughout the duration of the drink event;
a processor, for analyzing the recorded acoustic signature, and
optionally, an antenna, for transmitting the analysis of the processor; and
a power source, for supplying power to the smart components;
wherein the smart drinking container is configured to measure a volume of liquid withdrawn from the container body during the drink event based on the analysis of the processor.

10. The smart drinking container of claim 9, wherein the actuator is disposed in the fluid pathway.

11. The smart drinking container of claim 9, wherein the actuator is located on an external sidewall of the container body.

12. The smart drinking container of claim 11, wherein the actuator is activated by a physical stimulus.

13. The smart drinking container of claim 9, wherein the actuator is a sensor that is activated when the smart drinking container is tilted a number of degrees from vertical.

14. The smart drinking container of claim 9, further comprising an LED display, located on an external sidewall or the top surface of the lid.

15. The smart drinking container of claim 9, wherein the antenna is configured to transmit the analysis to a corresponding device, wherein the corresponding device can be a smart phone, a tablet, a personal computer or a smart watch.

16. The smart drinking container of claim 9, wherein the antenna is configured to transmit the analysis to a server of a web application.

17. The smart drinking container of claim 9, wherein the smart drinking container is configured to determine a total volume of liquid displaced during one or more drink events

18. A computer-implemented method for measuring a volume of liquid displaced from a smart bottle, the method including:
receiving, via an actuator, an indication of a drink event;
recording, via a microphone, an acoustic signature of a fluid flowing through a fluidic oscillator during the drink event;
transmitting, to one or more processors, the recorded acoustic signature once the drink event has terminated;
analyzing, with the one or more processors, the recorded acoustic signature to determine a volume of liquid withdrawn through the fluidic oscillator throughout the duration of the drink event; and,
optionally, transmitting, via an antenna, the determined volume of liquid displaced from the smart bottle.

19. The computer-implemented method of claim 18, wherein one or more drink events are analyzed to determine a total volume of liquid displaced during one or more drink events.

20. The computer-implemented method of claim 19, wherein the determined total volume of liquid displaced is displayed via a user interface of the smart bottle.
